(19) United States
(12) Patent Application Publication
(10) Pub. No.: US 2008/0073810 A1
(43) Pub. Date: Mar. 27, 2008

(54) Dope Filtering Method and Solution Casting Method Using The Dope

(75) Inventors: Takashi Ito, Kanagawa (JP); Tsuneo Kawase, Kanagawa (JP); Yoshihiro Tsukimi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/663,183

(22) PCT Filed: Sep. 20, 2005
(86) PCT No.: PCT/JP05/17665

§ 371 Date: Mar. 19, 2007

(30) Foreign Application Priority Data
Sep. 24, 2004 (JP) 2004-277174

(51) Int. Cl. C08J 5/18; B01D 35/02; C08L 1/10; B01D 39/10

(52) U.S. Cl. 264/217; 210/767; 210/774; 210/806; 264/212

(57) ABSTRACT

A dope (36) containing TAC and plasticizer is produced. Foreign materials in the dope (36) are filtrated by a filtration device (57). In the filtration device (57), the dope (36) flows from an outer passage (58a) to an inner passage (58b) through a filter (59). The filter (59) has a first layer (59a), a second layer (59b), and a third layer (59c), which are formed of sintered metal fibers. An average diameter of the sintered metal fibers of the first layer (59a) is 8 mm, that of the second layer (59b) is 4 mm, and that of the third layer (59c) is 20 mm. The filter (59) is roasted 2 hours at 400° C. and reused. Breakages from the sintered metal fibers in the first and second layers (59a, 59b) are filtrated in the third layer (59c).

### TECHNICAL FIELD

The present invention relates to a dope filtering method and a solution casting method using the dope, especially the dope filtering method and the solution casting method using the dope containing cellulose acylate and solvent.

### BACKGROUND ART

A film formed of cellulose acylate, especially cellulose triacetate (TAC) having acetylic degree between 57.5% and 62.5% is preferably used as a base film of a photosensitive material, because of having strength and flame resistance. In addition, the TAC film is excellent in an optical isotropy and therefore used as a protective film for a polarizing filter in a liquid crystal display, an optical compensation film (such as a wide viewing angle film) and the like whose markets are expanding recently.

The TAC film is generally produced by a solution casting method. The solution casting method can produce films having more superior optical properties than films produced by other methods such as a melt-extrusion method. In the solution casting method, a polymer solution (hereinafter called the dope) is prepared such that the polymer is dissolved in a mixed solvent mainly containing methylene chloride or methyl acetate. Then the dope is casted on a support from a casting die to form a casting film. After having a self-supporting property, the casting film is peeled as a wet film from the support. The wet film is dried and then wound as a film.

To remove foreign materials in the dope used for the solution casting, fiber forming or the like, filtration with use of a sintered metal fiber filter is generally applied to the dope. For example, Japanese Patent Laid-Open Publications No. 7-009584, No. 7-124421, No. 2001-213974, and No. 2002-363342 disclose the above filtration. The sintered metal fiber filter has a strong structure to endure a high-pressure loss, therefore this filter is adapted to filtrate the dope of high viscosity. As disclosed in Japanese Patent Laid-Open Publication No. 60-103103 and Japanese Examined Patent Publications No. 3-33370 and No. 3-39727, the sintered metal fiber filter is formed such that metal fibers are entwined into a felt, and welded in high temperature non-oxygenated atmosphere. A filtration accuracy of the sintered metal fiber can be easily regulated by changing a diameter of the metal fibers. Therefore, the sintered metal fiber filter is adapted to filter the dope for producing a film used for the liquid crystal display, which is especially required to include few foreign materials therein. In addition, the sintered metal fiber filter can be reused by roasting even after clogging. Accordingly, the used filter is not necessary to be disposed. A roasting method for reusing is disclosed in Japanese Examined Patent Publications No. 63-51727.

However, in case the sintered metal fiber filter is used for the filtration of the dope containing chlorinated solvent and then roasted for reuse, the metal fibers are possibly broken away from the filter and mixed in the dope, because the metal fiber is deteriorated by the roasting. If optical films are produced from the dope containing the breakages, defects of the product film possibly occur. Although the number of breakages from the metal fiber can be reduced by careful cleansing of the filter for removing the foreign materials therein before and after the roasting and adjusting the roasting condition properly, it is difficult to perfectly prevent the occurrence of the breakages. In addition, for improving the filtration accuracy of the sintered metal fiber filter, the metal fiber having smaller diameter is generally used for the filter. Accordingly, the more breakages are possibly generated. As stated above, the presence of the breakages of the metal fiber is obstacle for improving the filtration accuracy of the filter and effective removing of the foreign materials in the dope.

An object of the present invention is to provide a dope filtering method and a solution casting method using the dope, in which breakages from sintered metal fiber filter are not mixed in the dope while the filtering.

### DISCLOSURE OF INVENTION

In order to achieve the object and other objects, in a dope filtering method of the present invention, a dope containing a cellulose acylate and a solvent is filtered with use of a first filter formed of sintered metal fibers, then further filtered with use of a second filter formed of sintered metal fibers whose average diameter is in a range of 15 μm to 60 μm and larger than that of the first filter.

It is preferable that the first filter has plural layers, and an average diameter of the sintered metal fibers of at least one of the layers is in a range of 4 μm to 8 μm. It is preferable that the first filter and the second filter have cylindrical shapes, and are concentrically arranged such that the first filter is outside and the second filter is inside.

In a dope filtering method of the present invention, a filter for filtering a dope containing a cellulose acylate has plural layers formed of sintered metal fibers and arranged in a dope flow direction, and an average diameter of the sintered metal fibers of the each layer is different to that of the other layers. The average diameter of the sintered metal fibers of the layer positioned at most downstream side in the dope flow is in a range of 15 μm to 60 μm and that of at least one of other layers is in a range of 4 μm to 8 μm.

It is preferable that the filter is roasted in a temperature range of 350° C. to 500° C. to be reused. It is preferable that a non-metal filter for filtering the dope is provided in upstream from the sintered metal fiber filter in the dope flow direction. It is preferable that the non-metal filter is a paper filter or a fabric filter. It is preferable that the solvent is a chlorinated solvent. In the present invention, the chlorinated solvent is a methylene chloride or the like which is an aliphatic hydrocarbon with substitution of chlorine for hydrogen.

In a solution casting method of the present invention, a dope containing a cellulose acylate and a solvent is prepared, the dope is filtered according to the dope filtering method of the present invention, and then the dope is cast on a support to form a film. The cellulose acylate is preferably a cellulose acetate, and particularly a cellulose triacetate. It is preferable that the sintered metal fiber includes at least one of an austenitic stainless, a martensitic stainless, a ferritic stainless and a combination of them.

According to the present invention, the filter assembly has the first filter formed of the sintered metal fibers and the second filter formed of sintered metal fibers whose average diameter is in the range of 15 μm to 60 μm and larger than that of the first filter, and the first filter and the second filter are arranged in this order in the dope flow direction. Therefore, the first filter formed of the sintered metal fibers can filter the dope at desired filtration accuracy, to remove foreign materials in the dope. In addition, since the sintered metal fiber filter having high endurance is used, a filtration of high viscosity of the dope and a high flow volume filtration can be performed and the effectiveness of the filtration can be increased.

In addition, the second filter can filter breakages from the sintered metal fiber of the first filter. Therefore, the breakages are not entered into the dope, and the film having superior optical properties can be obtained from the filtrated dope.

Since the average diameter of the sintered metal fibers of the first filter is in the range of 4 μm to 8 μm, an amount of foreign materials contained in the dope became small, and the film having superior optical properties can be obtained from the filtrated dope.

Since the filter is roasted in a temperature range of 350° C. to 500° C. to be reused, a cost for the filtration can be reduced. Since the dope applied the filtration of above method is used for the solution casting, the film having superior optical properties can be obtained. In addition, since the sintered metal fiber includes at least one of the austenitic stainless, the martensitic stainless, the ferritic stainless and the combination of them, the filter can be roasted and reused many times for reducing the filtration cost.

### BRIEF DESCRIPTION OF DRAWINGS

FIG. 1 is a schematic view of a dope producing apparatus;

FIG. 2 is a schematic view of an apparatus for producing a film by solution casting; and

FIG. 3 is a cross-sectional view of a filtration device.

### BEST MODE FOR CARRYING OUT THE INVENTION

In the cellulose acylate to be used in the present invention, the degree of the acyl substitution preferably satisfies the following formulae (1-A) to (1-C):
2.5≦A+B≦3.0 (1-A)
0≦A≦3.0 (1-B)
0≦B≦2.9 (1-C)

In the formulae, A is a degree of substitution of the hydrogen atom of the hydroxyl group to the acetyl group, and B is a degree of substitution of the hydrogen group to the acyl group having 3-22 carbon atoms. Preferably, at least 90 mass % of the cellulose acylate particles has diameter from 0.1 mm to 4 mm. Note that the polymer used for preparing a dope is not limited to the cellulose acylate (TAC).

Solvent compounds for preparing the dope are aromatic hydrocarbons (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like.

The preferable solvent compounds are the halogenated hydrocarbons having 1 to 7 carbon atoms, and dichloromethane is especially preferable. In view of physical properties such as optical properties, a solubility, a peelability from a support, a mechanical strength of the film and the like, it is preferable to use at least one sorts of the alcohols having 1 to 5 carbon atoms with dichloromethane. The content of the alcohols is preferably in the range of 2 mass % to 25 mass %, and especially in the range of 5 mass % to 20 mass % to total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, alcohols with 1 to 12 carbon atoms, or a mixture of them (for example, a mixture of methyl acetate, acetone, ethanol and n-butanol). The ethers, ketones, esters and alcohols may have a cyclic structure. One solvent compound having at least two functional groups thereof (—O—, —CO—, —COO—, —OH) may be contained in the organic solvent.

The cellulose acylate is described in detail in the Japanese patent laid-open publication No. 2005-104148, and the description of the publication can be applied to the present invention. Further, as the solvent of cellulose acylate and other additives, the publication discloses plasticizers, deteoriation inhibitor, optical anisotropy controlling agent, dye, matting agent, release agent and release promoter in detail.

To improve properties of the produced film, several sorts of already known compounds can be added as additives to the dope. As the additives, there are plasticizers (triphenylphosphate, biphenyldiphenyl phosphate, Dipentaerythritol hexaacetate, Ditrimethylolpropane tetraacetate and the like), ultraviolet absorbing agents (oxybenzophenone compound, benzotriazole compound and the like), matting agents (particles of silicon dioxide and the like), thickeners, oil-gelation agents, retardation controlling agents (optical anisotropy controlling agents) and the like. however, the additives are not restricted in them. The additives may be added with the polymer to the solvent for preparing the dope. Otherwise, in the feeding of the prepared dope, the additives may be added to the dope to make an inline mixing. Further, the additives may be directly added in the dope, or a solution in which the additives are previously dissolved to the solvent may be added in the dope.

A film produced by adding materials having acidic property (hereinafter called acidic material) into the dope has superior peelability. As the acidic material, there are inorganic acids (hydrochloric acid and the like), organic acids (phenol and the like), organic carboxylic acids (acetic acid, lactic acid and the like), organic polycarboxylic acids (citric acid, tartaric acid and the like), organic polycarboxylic acid derivatives and the like. However, the acidic materials are not restricted in them. As the basic skeleton of the organic polycarboxylic acid derivatives, there are aliphatic hydrocarbons (straight-chain saturated, branched-chain saturated, straight-chain unsaturated, branched-chain unsaturated, monocyclic, aromatic, condensed polycyclic, bridged cyclic, spiro, ring assembly, terpene and the like), aromatic hydrocarbons (condensed polycyclic and the like), and heterocycles. However, the basic skeletons are not restricted in them. The added amount of the acidic material is preferably 200 ppm to 800 ppm to the polymer, so as not to adversely affect the optical properties of the produced film.

The compounds to be used as optical anisotropy controlling agents will be described in followings.

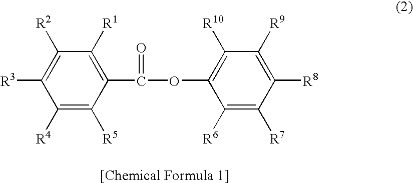

In the formula (2), R¹-R¹⁰ are independently hydrogen atom or substituent T which will be explained later. At least one of R¹-R⁵ is an electron donative substituent. The substituent having electron-donating property is preferably at least one of R¹, R³ and R⁵, and especially R³.

In the group having electron-donating property, a σp value of Hammet is at most zero. The Op value of Hammet described in Chem. Rev., 91, 165 (1991) is preferably at most zero, and especially in the range of −0.85 to 0, Such groups are, for example, alkyl groups, alkoxy groups, amino groups, hydroxy groups, and the like.

The groups having electron-donating property are preferably alkyl groups and alkoxy groups, and particularly alkoxy groups in which the number of carbon atoms is preferably from 1 to 12, particularly from 1 to 8, especially from 1 to 6, and more especially 1 to 4.

R¹ is preferably hydrogen atom or a substituent having electron-donating property, particularly alkyl group, alkoxy group, amino group and hydroxy group, and especially alkyl group having 1-4 carbon atoms and alkoxy group having 1-12 carbon atoms. R¹ is more especially alkoxy group in which the number of carbon atoms is preferably from 1 to 12, particularly from 1 to 8, especially from 1 to 6, and more especially 1 to 4, and most especially methoxy group.

R² is preferably hydrogen atom, alkyl group, alkoxy group, amino group and hydroxy group, particularly hydrogen atom, alkyl group and alkoxy group. R² is more especially hydrogen atom, alkyl group which has 1-4 carbon atoms or is further preferably methyl group, alkoxy group in which the number of carbon atoms is preferably from 1 to 12, particularly from 1 to 8, especially from 1 to 6, and more especially 1 to 4. The most especially group as R² is hydrogen atom, methyl group and methoxy group.

R³ is preferably hydrogen atom or a substituent having electron-donating property, particularly hydrogen atom, alkyl group, alkoxy group, amino group and hydroxy group, and especially alkyl group and alkoxy group. R³ is more especially alkoxy group in which the number of carbon atoms is preferably from 1 to 12, particularly from 1 to 8, especially from 1 to 6, and more especially 1 to 4. R³ is most especially n-propoxy group, ethoxy group and methoxy group.

R⁴ is preferably hydrogen atom or a substituent having electron-donating property, particularly hydrogen atom, alkyl group, alkoxy group, amino group and hydroxy group, and especially hydrogen atom, alkyl group having 1-4 carbon atoms and alkoxy group having 1-12 carbon atoms. R⁴ is more especially alkoxy group in which the number of carbon atoms is preferably from 1 to 12, particularly from 1 to 8, especially from 1 to 6, and more especially 1 to 4. R⁴ is most especially hydrogen atom, methyl group, and methoxy group.

R⁵ is preferably hydrogen atom, alkyl group, alkoxy group, amino group and hydroxy group, particularly hydrogen atom, alkyl group and alkoxy group. R⁵ is more especially hydrogen atom, alkyl group which has 1-4 carbon atoms or is further preferably methyl group, and alkoxy group in which the number of carbon atoms is preferably from 1 to 12, particularly from 1 to 8, especially from 1 to 6, and more especially 1 to 4. The most especially group as R⁵ is hydrogen atom, methyl group and methoxy group.

R⁶, R⁷, R⁹ and R¹⁰ preferably hydrogen atom, alkyl group having 1 to 12 carbon atoms, alkoxy group having 1 to 12 carbon atom and halogen atoms, particularly hydrogen atom and halogen atoms, and especially hydrogen atom.

R⁸ is preferably hydrogen atom, alkyl group having 1-4 carbon atoms, alkynyl group having 2-6 carbon atoms, aryl group having 6-12 carbon atoms, alkoxy group having 1-12 carbon atoms, and aryloxy group having 6-12 carbon atoms. R⁸ is particularly preferably alkoxy carbonyl group having 2-12 carbon atoms, acylamino group having 2-12 carbon atoms, ciano group and halogen atom. These groups may have a substituent T which will be explained later.

R⁸ is preferably alkyl group having 1-4 carbon atoms, alkynyl group having 2-6 carbon atoms, aryl group having 6-12 carbon atoms, alkoxy group having 1-12 carbon atoms, aryloxy group having 2-12 carbon atoms, and particularly aryl group having 6-12 carbon atoms, alkoxy group having 1-12 carbon atoms, aryloxy group having 6-12 carbon atoms. R⁸ is especially preferably alkoxy group in which the number of carbon atoms is preferably from 1 to 12, particularly from 1 to 8, especially from 1 to 6, and more especially 1 to 4. The most especially group as R⁸ is methoxy group, ethoxy group, n-propoxy group, iso-propoxy group and n-butoxy group.

In Chemical Formula 1 (formula (2)), there are preferable compounds shown in Chemical Formula 2 (following formula (2-A)).

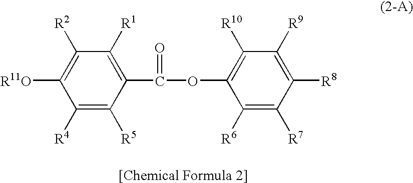

In the formula (2-A), R¹¹ is alkyl group, and R¹, R², R⁴-R⁷, R⁹, R¹⁰ are independently hydrogen atom or substituents. R⁸ is hydrogen atom, alkyl group having 1-4 carbon atoms, alkynyl group having 2-6 carbon atoms, aryl group having 6-12 carbon atoms, alkoxy group having 1-12 carbon atoms, aryloxy group having 6-12 carbon atoms, alkoxy carbonyl group having 2-12 carbon atoms, acylamino group having 2-12 carbon atoms, ciano group and halogen atom. In Chemical Formula 2 (formula (2-A)), R¹, R², R⁴-R¹⁰ and the preferable range of the number of the carbon atoms in one molecule are the same as in Chemical Formula 1 (formula (2)).

In formula (2-A), R¹¹ is preferably alkyl group having 1-12 carbon atoms, and may have straight chain or branched chain. Further, R¹¹ may have substituents and be preferably alkyl group having 1-12 carbon atoms, particularly alkyl group having 1-8 carbon atoms, especially alkyl group having 1-6 carbon atoms, and more especially alkyl group having 1-4 carbon atoms (for example, methyl group, ethyl group, n-propyl group, iso-propyl group, n-butyl group, iso-butyl group, tert-butyl group and the like.

In Chemical Formula 1 (formula (2)), there are preferable compounds shown in Chemical Formula 3 (following formula (2-B)).

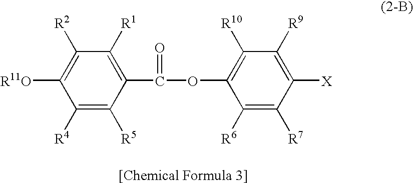

In the formula (2-B), R¹, R², R⁴-R⁷, R⁹, R¹⁰ are independently hydrogen atom or substituents. R¹¹ is a alkyl group having 1 to 12 carbon atoms. X is alkyl group having 1-4 carbon atoms, alkynyl group having 2-6 carbon atoms, aryl group having 6-12 carbon atoms, alkoxy group having 1-12 carbon atoms, aryloxy group having 6-12 carbon atoms, alkoxy carbonyl group having 2-12 carbon atoms, acylamino group having 2-12 carbon atoms, ciano group and halogen atom.

In Chemical Formula 3 (formula (2-B)), R¹, R², R⁴-R⁷, R⁹, R¹⁰ and the preferable range of the number of the carbon atoms in one molecule are the same as in Chemical Formula 1 (formula (2)), and R⁸ and the preferable range of the number of the carbon atoms in one molecule are the same as in Chemical Formula 2 (formula (2-A)).

If R¹, R², R⁴, R⁵ are hydrogen atoms, X is preferably alkyl group, alkynyl group, aryl group, alkoxy group, aryloxy group, and particularly aryl group, alkoxy group, aryloxy group, especially alkoxy group in which the number of carbon atoms is preferably from 1 to 12, particularly from 1 to 8, especially from 1 to 6, and more especially 1 to 4. The most especially preferable group as X is methoxy group, ethoxy group, n-propoxy group, iso-propoxy group and n-butoxy group.

If at least one of R¹, R², R⁴ and R⁵ is substituent, X is preferably alkynyl group, aryl group, alkoxy carbonyl group and ciano group, and preferably aryl group having 6-12 carbon atoms, alkoxy carbonyl group having 2-12 carbon atoms and ciano group. Further, X is especially preferably ciano group, aryl group which has 6-12 carbon atoms (particularly phenyl group, p-cianophenyl group and p-methoxyphenyl group), alkoxycarbonyl group which has preferably 2-12, particularly 2-6 and especially 2-4 carbon atoms and is especially methoxy carbonyl group, ethoxy carbonyl group and n-propoxycarbonyl group. The most especially group as X is phenyl group, methoxy carbonyl group, ethoxy carbonyl group, n-propoxy group and cyano group.

In Chemical Formula 1 (formula (2)), there are preferable compounds shown in Chemical Formula 4 (following formula (2-C)).

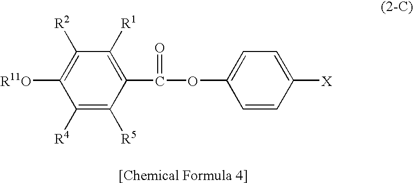

In Chemical Formula 4 (formula (2-C)), R¹, R², R⁴, R⁵, R¹¹ and the preferable range of the number of the carbon atoms in one molecule are the same as in Chemical Formula 3 (formula (2-B)).

In Chemical Formula 1 (formula (2)), there are preferable compounds shown in Chemical Formula 5 (following formula (2-D)).

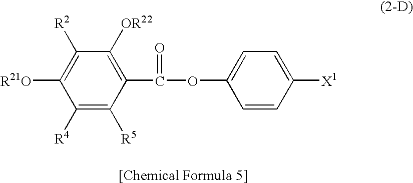

In Chemical Formula 5 (formula (2-D)), R², R⁴, R⁵ and the preferable range of the number of the carbon atoms in one molecule are the same as in Chemical Formula 4 (formula (2-C)). R²¹, R²² are independently alkyl group having 1-4 carbon atoms. X¹ is aryl group having 6-12 carbon atoms, alkoxyl carbonyl group having 2-12 carbon atoms, or cyano group.

R²¹ is alkyl group having 1-4 carbon atoms, preferably alkyl group having 1-3 carbon atoms, and particularly methyl group and ethyl group. R²² is alkyl group having 1-4 carbon atoms, preferably alkyl group having 1-3 carbon atoms, particularly methyl group and ethyl group, and especially methyl group.

X¹ is aryl group having 6-12 carbon atoms, alkoxyl carbonyl group having 2-12 carbon atoms, and cyano group, and preferably aryl group having 6-10 carbon atoms, alkoxyl carbonyl group having 2-6 carbon atoms, and cyano group. X¹ is especially preferably phenyl group, p-cianophenyl group, p-methoxyphenyl group, methoxycarbonyl group, ethoxy carbonyl group, n-propoxy carbonyl group, and cyano group, and more especially phenyl group, methoxycarbonyl group, ethoxycarbonyl group, n-propoxycarbonyl group, and cyano group.

In Chemical Formula 1 (formula (2)), there is most preferable compounds shown in Chemical Formula 6 (following formula (2-E)).

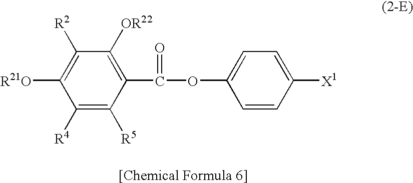

In Chemical Formula 6 (formulae (2-E)), R², R⁴, R⁵ and the preferable range of the number of the carbon atoms in one molecule are the same as in Chemical Formula 5 (formula (2-D)). As shown in Chemical Formulae 6, OR¹³ is substituent for one of R², R⁴, R⁵, and R¹³ is alkyl group having 1-4 carbon atoms. R², R²², X¹ and the preferable range of the number of the carbon atoms in one molecule are the same as in Chemical Formula 5 (formula (2-D)).

Preferably, both R⁴ and R⁵ are OR¹³, and especially R⁴ is OR¹³. R¹³ is alkyl group having 1-4 carbon atoms, preferably alkyl group having 1-3 carbon atoms, particularly methyl group and ethyl group, and especially methyl group.

In followings, the substituents T will be explained. As the substituents, there are, for example, alkyl groups in which the number of the carbon atoms is preferably from 1 to 20, particularly from 1 to 12, especially from 1 to 8. Concretely, the alkyl group is methyl group, ethyl group, iso-propyl group, tert-butyl group, n-octyl group, n-decyl group, n-hexadecyl group, cyclopropyl group, cyclopentyl group, cyclohexyl group and the like. Further, as the substituents, there are, for example, alkenyl groups in which the number of the carbon atoms is preferably from 2 to 20, particularly from 2 to 12, especially from 2 to 8 (concretely, vinyl, allyl group, 2-butenyl group, 3-pentenyl group and the like), alkynyl groups in which the number of the carbon atoms is preferably from 2 to 20, particularly from 2 to 12, especially from 2 to 8 (concretely, propargyl group, 3-pentynyl group and the like).

Further, as the substituents, there are, for example, aryl groups in which the number of the carbon atoms is preferably from 6 to 30, particularly from 6 to 20, especially from 6 to 12. Concretely there are phenyl group, p-methylphenyl group, naphtyl group and the like. Furthermore, as the substituents, there are, for example, substituted or non-substituted amino groups in which the number of the carbon atoms is preferably from 0 to 20, particularly from 0 to 10, especially from 0 to 6 (concretely, there are amino group, methylamino group, dimethylamino group, diethylamino group, dibenzylamino group, and the like), alkoxy groups in which the number of the carbon atoms is preferably from 1 to 20, particularly from 1 to 12, especially from 1 to 8 (concretely, methoxy group, ethoxy group, butoxy group and the like), aryloxy groups in which the number of the carbon atoms is preferably from 6 to 20, particularly from 6 to 16, especially from 6 to 12 (concretely, phenyloxy group, 2-naphthyloxy group and the like).

Further, as the substituents, there are acyl groups in which the number of the carbon atoms is preferably from 1 to 20, particularly from 1 to 16, especially from 1 to 12. Concretely, there are acetyl group, benzoyl group, formyl group, pivaloyl group, and the like. Further, as the substituents, there are alkoxy carbonyl groups in which the number of the carbon atoms is preferably from 2 to 20, particularly from 2 to 16, especially from 2 to 12. Concretely, there are methoxycarbonyl group, ethoxycarbonyl group and the like. Further, as the substituents, there are aryloxycarbonyl groups in which the number of the carbon atoms is preferably from 7 to 20, particularly from 7 to 16, especially from 7 to 10. Concretely, there are phenyloxycarbonyl group and the like. Further, as the substituents, there are acyloxy groups in which the number of the carbon atoms is preferably from 2 to 20, particularly from 2 to 16, especially from 2 to 10. Concretely, there are acetoxy group, benzoyloxy group and the like.

Further, as the substituents, there are acylamino groups in which the number of the carbon atoms is preferably from 2 to 20, particularly from 2 to 16, especially from 2 to 10. Concretely, there are acetylamino group, benzoylamino group and the like. Further, as the substituents, there are alkoxycarbonylamino groups in which the number of the carbon atoms is preferably from 2 to 20, particularly from 2 to 16, especially from 2 to 12. Concretely, there are methoxycarbonylamino group and the like. Further, as the substituents, there are aryloxycarbonylamino groups in which the number of the carbon atoms is preferably from 7 to 20, particularly from 7 to 16, especially from 7 to 12. Concretely, there are phenyloxycarbonylamino group and the like. Further, as the substituents, there are sulfonylamino groups in which the number of the carbon atoms is preferably from 1 to 20, particularly from 1 to 16, especially from 1 to 12. Concretely, there are methanesulfonyl amino group, benzene sulfonylamino group and the like.

Further, as the substituents, there are sulfamoyl groups in which the number of the carbon atoms is preferably from 0 to 20, particularly from 0 to 16, especially from 0 to 12. Concretely, there are sulfamoyl group, methylsulfamoyl group, dimethylsulfamoyl group, phenylsulfamoyl group and the like. Further, as the substituents, there are carbamoyl groups in which the number of the carbon atoms is preferably from 1 to 20, particularly from 1 to 16, especially from 1 to 12. Concretely, there are carbamoyl group, methylcarbamoyl group, diethylcarbamoyl group, phenylcarbamoyl group and the like. Furthermore, as the substituents, there are alkylthio groups in which the number of the carbon atoms is preferably from 1 to 20, particularly from 1 to 16, especially from 1 to 12. Concretely, there are methylthio group, ethylthio group and the like. Furthermore, as the substituents, there are arylthio groups in which the number of the carbon atoms is preferably from 6 to 20, particularly from 6 to 16, especially from 6 to 12. Concretely, there are phenylthio group.

Further, as the substituents, there are sulfonyl groups in which the number of the carbon atoms is preferably from 1 to 20, particularly from 1 to 16, especially from 1 to 12. Concretely, there are mesyl group, tosyl group and the like. Further, as the substituents, there are sulfinyl groups in which the number of the carbon atoms is preferably from 1 to 20, particularly from 1 to 16, especially from 1 to 12. Concretely, there are methane sulfinyl group, benzene sulfinyl group and the like. Further, as the substituents, there are ureido groups in which the number of the carbon atoms is preferably from 1 to 20, particularly from 1 to 16, especially from 1 to 12. Concretely, there are ureido group, methylureido group, phenylureido group and the like. Furthermore, as the substituents, there are phosphoric acid amide groups in which the number of the carbon atoms is preferably from 1 to 20, particularly from 1 to 16, and especially from 1 to 12. Concretely, there are diethylphosphoric acid amide group, phenylphosphoric acid amide group and the like.

Further, as the substituents, there are hydroxy groups, mercapto groups, halogen atoms (fluorine atom, chlorine atom, bromine atom, iodine atom an the like), cyano groups, sulfo groups, carboxy group, nitro group, hydroxamic acid group, sulfino group, hydrazino group, imino group, heterocyclic group in which the number of the carbon atoms is preferably from 1 to 30, particularly from 1 to 12 and there are nitrogen atom, oxygen atom, sulfur atom and the like as the heteroatom. As the heterocyclic group, for example, there are imidazolyl group, pyridyl group, quinoryl group, furyl group, piperidyl group, morphorino group, benzoxazolyl group, benzimidazolyl group, benzthiazolyl group and the like. Further, as the substituents, there are silyl group in which the number of the carbon atoms is preferably from 3 to 40, particularly from 3 to 30 and especially from 3 to 24, and there are trimethyl silyl, triphenyl silyl and the like.

In followings chemical formulae, concrete examples of the compounds shown in Chemical formula 1 (formula (2)) will be illustrated. However, the present invention is not restricted in the concrete examples.

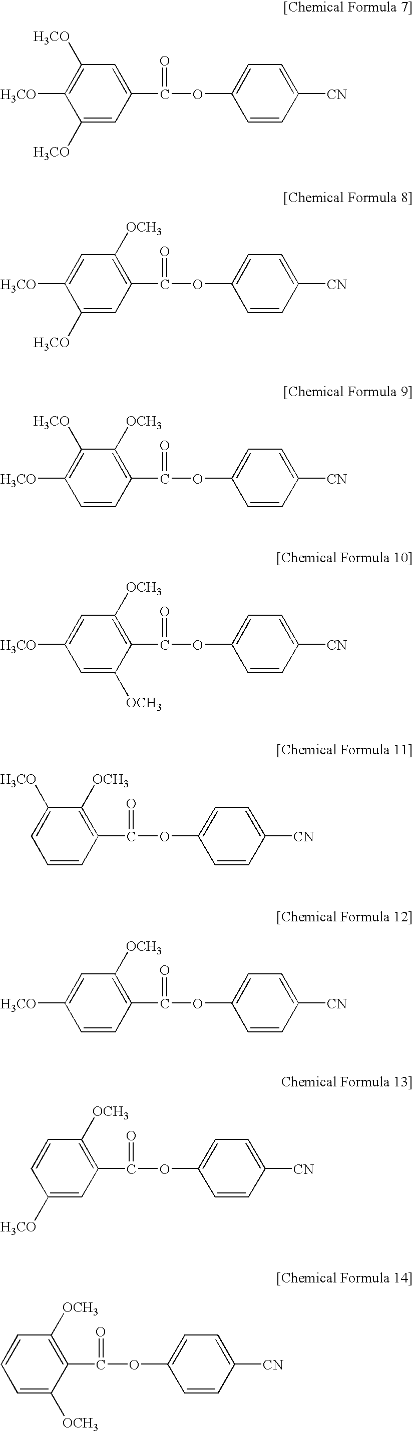

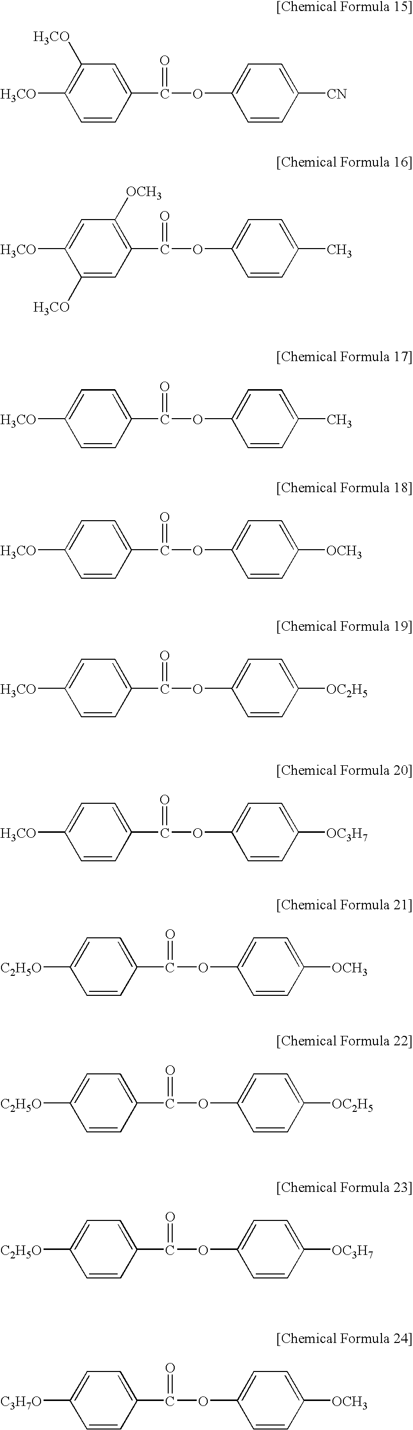

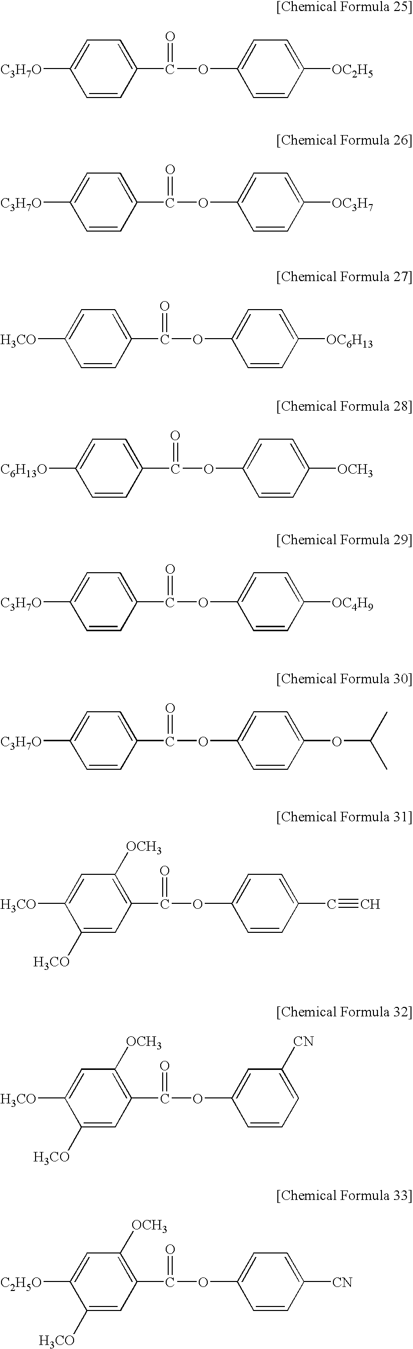

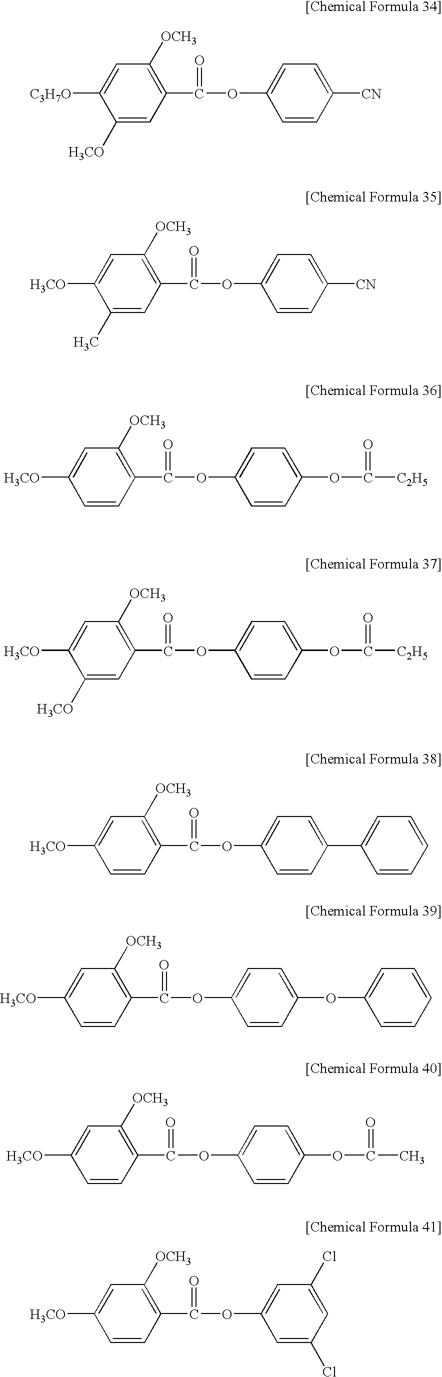

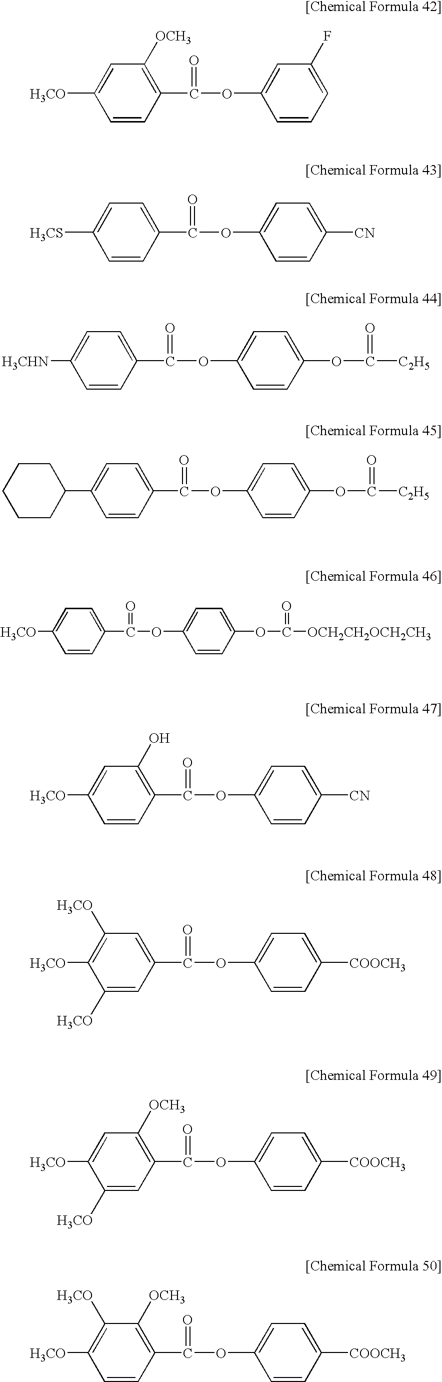

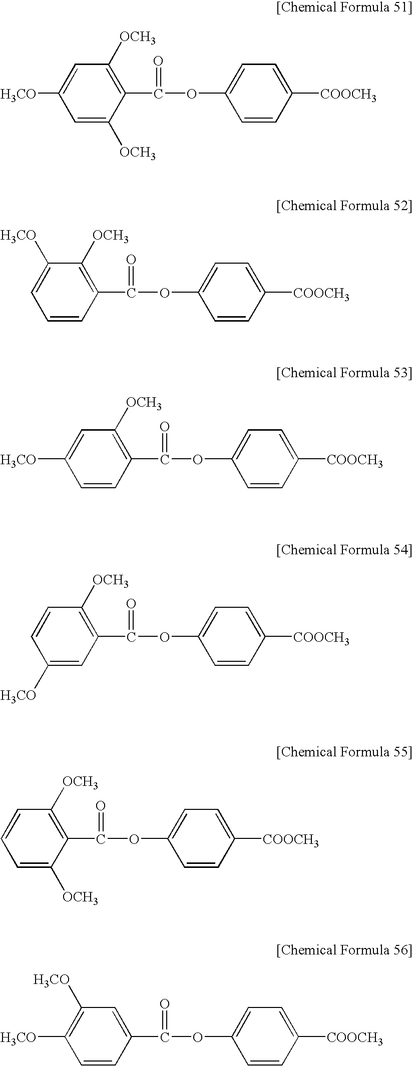

The compounds represented by Chemical Formula 1 (formula (2)) can be produced in a general esterification reaction of substituted benzoic acid and phenol derivatives. The method of the production is not restricted so far as being esterification reaction. For example, there are a method in which a functional group transformation of the substituted benzoic acid to an acid halide is made and thereafter a condensation with the phenol is made, a method in which the dehydration condensation between substituted benzoic acid and the phenol derivatives with use of condensation agent or catalyst, and the like. In consideration of the producing process, the method in which the condensation with phenol is made after the functional group transformation of the substituted benzoic acid to the acid halide.

As the solvent for the reaction, there are hydrocarbon type solvent (preferably toluene, xylene and the like), ether type solvent (preferably diethylether, tetrahydrofuran, dioxane and the like), ketone type solvent, ester type solvent, acetonitril, dimethylformamide, dimethylacetoamide and the like. Single one or the mixture of these compounds may be used as the solvent. Especially preferable solvents are toluene, acetonitril, dimethylformamide, dimethylacetoamide and the like.

The reaction temperature is preferably in the range of 0° C. to 150° C., particularly in the range of 0° C. to 100° C., especially in the range of 0° C. to 90° C., and more especially 20° C. to 90° C. In this reaction, it is preferable not to use a base. When the base is used, the organic and inorganic bases may be used. However, the organic base is preferably used, and pyridine and tertiary alkylamine (preferably triethylamine, ethyldiisopropyl amine and the like) are particularly preferably used.

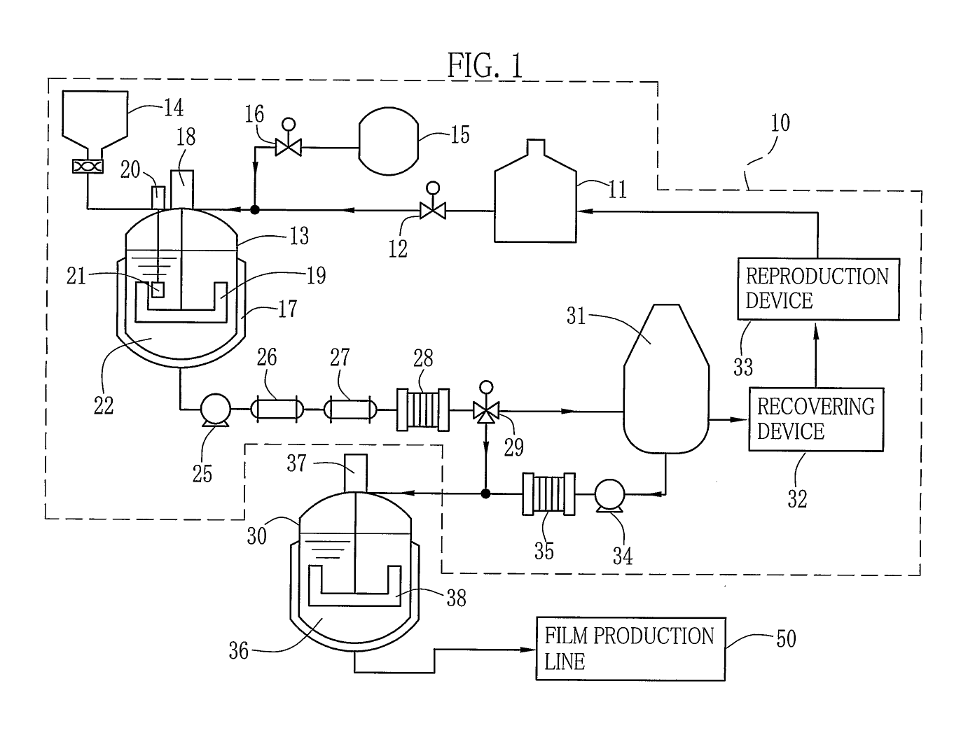

As shown in FIG. 1, the dope is made in a dope production line 10 by a method as described below. At first, the solvent is transported from a solvent tank 11 to a dissolving tank 13 by opening a valve 12. Next, the measured volume of TAC is transported from a hopper 14 to the dissolving tank 13, and the required volume of additive liquid (for example, the solution including the plasticizer) is transported from an additive tank 15 to the dissolving tank 13 by opening and closing a valve 16. Note that there are other methods except for additives to be transported as the solution. For example, the additives can be directly transported into the dissolving tank 13 if additives are in liquid state at the normal temperature. The additives can be transported into the dissolving tank 13 by a hopper if the additive is in solid state. If plural kinds of additives are used, it can be that a solution dissolving all of them is stored in the additive tank 15, and it can be that each of solutions including single additive is stored in a separate additive tank and transported into the dissolving tank 13 through each corresponding pipe.

In the above embodiment, the order in which materials transported into the dissolving tank 13 is the solvent, the TAC and additives. However, the order is not restricted to this way. For example, after the TAC is transported into the dissolving tank 13, intended volume of the solvent can be transported. In addition, additives is not required to be preliminarily stored in the dissolving tank 13, but can be mixed into a mixture of the TAC and the solvent at the after process (hereinafter the mixture is also called the dope).

The dissolving tank 13 comprises a jacket 17 which covers the outside of the tank 13, and a first stirrer 19 rotated by a motor 18. Further, preferably the dissolving tank 13 comprises a second stirrer 21 rotated by a motor 20. Note that preferably the first stirrer 19 is a anchor blade and the second stirrer 21 is dissolver type. Temperature inside the dissolving tank 13 is preferably regulated by a heating medium flowing in the jacket 17. The temperature is preferably in the range of −10° C. to 55° C. By individually controlling the rotation of the first stirrer 19 and the second stirrer 21, a swelling liquid 22 in which the TAC swells in the solvent is made.

Next, the swelling liquid 22 is transported to a heater 26 by a pump 25. Preferably, the heater 26 has a jacketed pipe and a pressure device for pressurizing inside the pipe. In the heater 26, the TAC and other components in the swelling liquid 22 are dissolved in the solvent by being heated or by being heated and pressurized. Note that preferably temperature of the swelling liquid 22 is heated in a range of 50° C. to 120° C. (hereinafter this method is called the heating dissolution method). A known cooling dissolution method, in which the temperature of the swelling liquid 22 is cooled in a range of −100° C. to −30° C., is also applicable to obtain the dope. The heating and cooling dissolution methods are selected according to the properties of the TAC for the dissolving. A temperature of the dope is controlled to approximately room temperature by a heat controller 27, and then the dope is filtrated by the filtration device 28 so that foreign materials are removed from the dope. Preferably the average hole diameter of a filter in the filtration device 28 is less than 10 {m. Preferably flow rate of the filtration is equal to or more than 50 liter/hour. The dope after the filtration is stored in a reserve tank 30 through a valve 29. A stirrer 38 rotated by a motor 37 is provided in the reserve tank 30 to keep uniformity of the dope 36.

The method stated above, that once the swelling liquid 22 is prepared and then making the dope from the swelling liquid 22, possibly needs high product cost, because longer manufacturing time is required to make the dope having higher concentration of the TAC. To reduce the cost, it is preferable that a dope having the TAC in lower concentration than a desired concentration is prepared, and then a concentration process is performed, in which the concentration of the TAC is elevated to the desired concentration. For the concentration process being applied to the dope, the dope filtrated in a filtration device 28 is transported into the flushing device 31 through the valve 29, so that a part of solvent in the dope is vaporized in the flushing device 31. The solvent vapor is condensed into liquid by a condenser (not shown). The liquid is recovered by the recovering device 32 and reproduced by the reproduction device 33 to be reused as the solvent for preparing the dope. This recycling process has an advantage in terms of cost.

The condensed dope 36 is drawn from the flushing device 31 out by a pump 34. Further, preferably air bubbles generated in the dope 36 are removed. Any known methods to remove the air bubble are applicable (for example, ultrasonic irradiation method). Next, the dope 36 is transported to the filtration device 35 in which foreign materials in the dope 36 are removed. Note that the temperature of the dope 36 when being applied these processes is preferable in a range of 0° C. to 200° C. The TAC concentration is preferably in a range of 5 mass % to 40 mass %, especially in a range of 15 mass % to 30 mass %, particularly in a range of 17 mass % to 25 mass %. A concentration of the additives (mainly composed of the plasticizer) is preferably in the range of 1 mass % to 20 mass % to total solid components in the dope. The dope 36 is transported to and stored in the reserve tank 30.

Note that methods for adding and dissolving raw materials and additives of a dope, filtering the dope, removing bubbles, and other methods in the solution casting method for producing the TAC film are explained in Japanese Patent Laid-open publication No. 2005-104148. The content of this publication can be applied to the present invention.

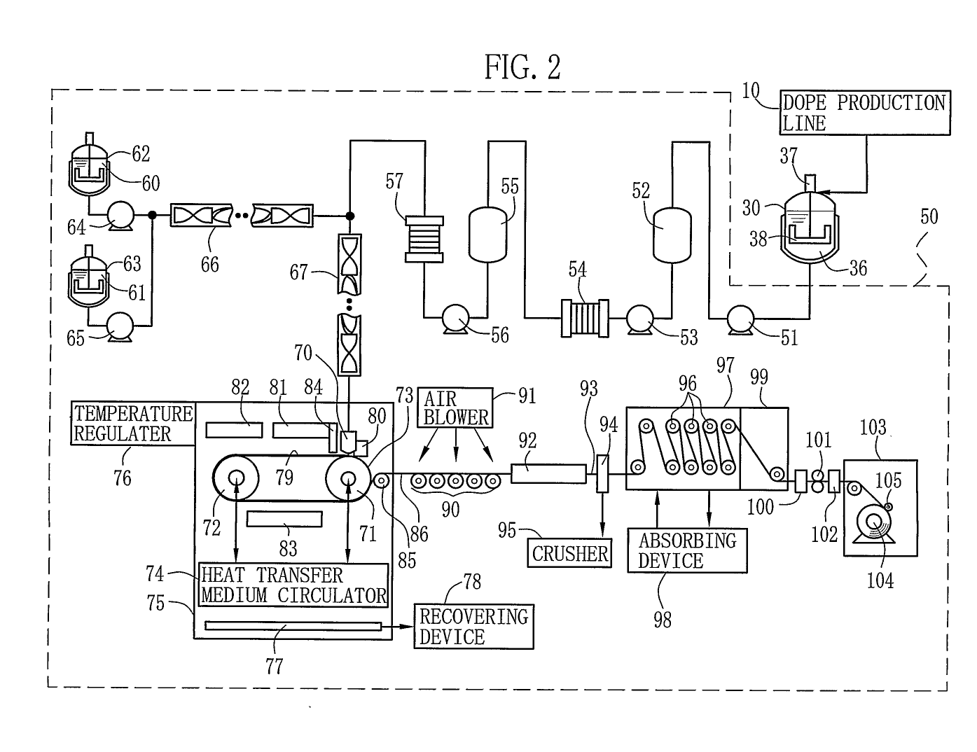

As shown in FIG. 2, the dope 36 in the reserve tank 30 is transferred to a stock tank 52 by a pump 51. Then the dope 36 is transferred to a first filtration device 54, and the filtrated dope is transferred to a stock tank 55, by operation of a pump 53. As materials of the filter of the first filtration device 54, paper filters, fabric filters, nonwoven fabrics, diatom filters and the like are preferably used. Especially, the paper filters, the fabric filters and combinations of them are suited.

As a form of the filter of the first filtration device 54, a membrane filter, a surface filter, a depth filter or the like can be used. An absolute filtration accuracy of the filter is preferably in a range of 5 μm to 50 μm. The absolute filtration accuracy is defined by JIS Z 8901. A measurement method for the absolute filtration accuracy will be schematically described below. Testing liquid, that is glass beads having different diameters as testing powders in pure water, is stirred by a stirrer in a beaker. The testing liquid is filtrated through a testing filter by suction of a vacuum pump in a condition −4 kPa from atmosphere pressure. A number of beads in an unit volume of the unfiltrated testing liquid and that of the filtrated testing liquid are measured through a microscope, and a particle collection efficiency is calculated as a below formula. The absolute filtration accuracy is a diameter of the particle when the particle collection efficiency is 95%.
Particle collection efficiency (%)=(number of beads in unit volume of infiltrated testing liquid−number of beads in unit volume of filtrated testing liquid)/(number of beads in unit volume of infiltrated testing liquid)*100

When the absolute filtration accuracy of the first filtration device 54 is less than 5 μm, possibly the filtration life is too short to produce the film effectively. When the absolute filtration accuracy of the first filtration device 54 is more than 50 μm, it is possible that the filter cannot remove some foreign materials in the dope, which cause defects of the film. Further, in this case, a filtration device provided downstream side from the first filtration device 54, such as a second filtration device described in FIG. 2, possibly needs to filtrate excessive quantities of the foreign materials.

At the first filtration device 54, a large quantity of foreign materials, including insoluble content of ingredients and foreign substances such as packaging materials and the like from outside of the dope producing process, are filtrated. Therefore, the filter of the first filtration device 54 is hardly reused by recycling. For the above reason, the non-metal filter such as the paper filters, the fabric filters, the nonwoven fabrics, the diatom earth filters and the like, which are low-cost and disposable, are used as the filter of the first filtration device 54.

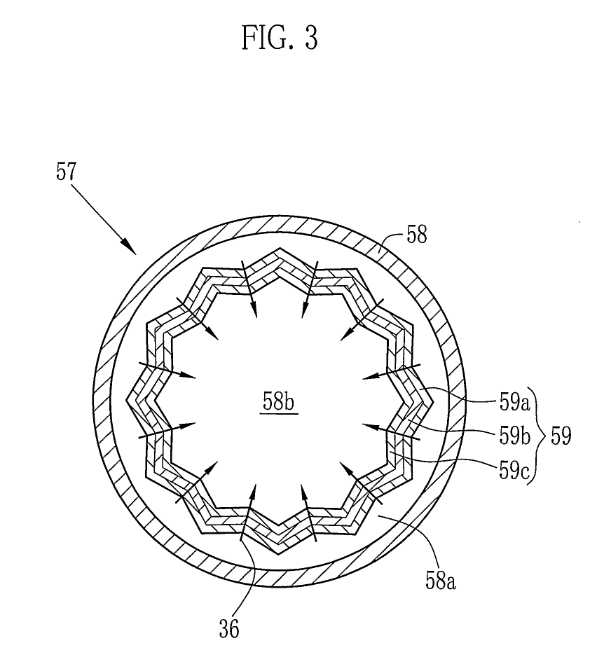

The dope 36 in the stock tank 55 is transferred to a second filtration device 57 by a pump 56, to be filtrated. As shown in FIG. 3, the second filtration device 57 has a structure that a cylindrical filter 59 is in a cylindrical housing 58. The material of the filter 59 is preferably austenitic stainless, martensitic stainless, ferritic stainless or combination of them, especially the austenitic stainless.

Since sintered metal fiber of stainless is used as the filter, when the dope containing chlorinated solvents is filtrated, it is prevented that the hydrochloric acid and the like corrode the filter and the foreign materials are generated by the corrosion. In addition, the sintered metal fiber is preferable for the filter, because the sintered metal fiber filter has larger porosity and smaller pressure loss than that of the metal filter, such as a sintered powder filter and a wire mesh filter.

The filter 59 has a layered structure, there are a first layer 59a, a second layer 59b and a third layer 59c arranged in this order in a flow direction of the dope. Each of the layers 59a-59c is formed of the sintered metal fiber. An average diameter of the metal fiber used for the first layer 59a is in a range of 8 μm to 60 μm. An average diameter of the metal fiber used for the second layer 59b is in a range of 4 μm to 8 μm. An average diameter of the metal fiber used for the third layer (the lowermost layer) 59c is in a range of 15 μm to 60 μm. Preferably, that of the first layer 59a is in a range of 8 μm to 30 μm, and that of the third layer 59c is in a range of 15 μm to 30 μm. According to the above structure, the third layer 59c can be catch breakages of the layers caused by roasting.

The number of layers of the filter is not limited to this embodiment. The number is preferably in a range of 2 to 6, particularly in a range of 2 to 5, especially in a range of 2 to 4. The thickness of the each layer is preferably in a range of 0.2 mm to 1 mm. The thickness of the filter 59 is preferably in a range of 0.6 mm to 1.5 mm. The absolute filtration accuracy of the filter 59 is preferably in a range of 1 μm to 50 μm, particularly in a range of 3 μm to 40 μm, especially in a range of 5 μm to 20 μm.

In the above embodiment, the second filtration device 57 has the filter 59 of the three-layer structure. However, the second filtration device may be formed such that plural cylindrical filters having a single layer are stacked concentrically. In this case, the cleansing and roasting for reusing can be applied to the filters separately or integrally. In addition, the filter may be pleated to increase contact area between the filter and the liquid.

The dope 36 entered in the second filtration device 57 flows from an outer passage 58a to an inner passage 58b through the filter 59, and then exits from the second filtration device 57. The dope 36 passes the first layer 59a, the second layer 59b, and the third layer (lowermost layer) 59c of the filter 59 in this order. Accordingly, breakages from the sintered metal fibers of the first and second layers 59a, 59b are caught in the third layer 59c, which is the lowermost layer, so that the breakages do not flow into the inner passage 58b. Note that flow pressure through the filter 59 is preferably in a range of 1*10⁵ Pa to 1*10⁶ Pa. To reduce the flow pressure below 1*10⁵ Pa, the absolute filtration accuracy needs to be increased, that possibly causes a difficulty of producing the dope having appropriate qualities. In addition, if the flow volume is reduced, the productivity of the dope becomes reduced. To increase the flow pressure over 1*10⁶ Pa, the housing 58 needs to have higher endurance, that causes an increase of the cost for the filtration device 57.

To reuse the filter 59 of the second filtration device 57, the filter 59 is roasted in a temperature at which the metal fiber is not melted. Accordingly, filter cake adhered on the sintered metal fiber of the filter 59 can be eliminated by combustion. When stainless is used for the sintered metal fiber, the roasting temperature is preferably in a range of 350° C. to 500° C., particularly in a range of 350° C. to 450° C., especially in a range of 350° C. to 420° C. The roasting time is preferably in a range of 2 hours to 8 hours, particularly in a range of 2 hours to 6 hours, especially in a range of 2 hours to 5 hours. According to the roasting in the above conditions, the foreign materials caught in the filter can be effectively eliminated, and the generation of the breakages of the filter is reduced. When the roasting time is less than 2 hours, the elimination of the filter cake cannot be completely performed. When the roasting time is more than 8 hours, although the filter cake can be completely eliminated, the roasting cost is increased and the roasting efficiency is reduced. In addition, there is possibility that the breakages from the filter are increased because of the excessive roasting. Note that when heating rate of the roasting is in a range of 5° C./min to 100° C./min, the increase of the breakages is prevented because the metal fiber is not rapidly heated.

An additive liquid 60 and a matting agent liquid 61 are added in inline into the dope 36 filtrated by the second filtration device 57. The additive liquid (for example a UV-absorbing agent solution) 60 and the matting agent liquid 61 are prepared and stored in stock tanks 62 and 63 respectively. The additive liquid 60 and the matting agent liquid 61 are pumped out from the stock tanks 62,63 by pumps 64,65. The additive liquid 60 and the matting agent liquid 61 are mixed and uniformed in a static mixer 66, and then added into the dope 36 in inline. Although type of the static mixer 66 is not limited, it is preferable that when a static mixer of NORITAKE Co., Ltd. having 15 mm to 25 mm of pipe diameter is used, there are 30 to 80 elements therein. Other inline mixers having same mixing performance, such as Sulzer mixer of Sulzer Corporation, and HiMixer of Toray Industries, Inc. may be preferably used.

After the additive liquid 60 and the matting agent liquid 61 are added into the dope 36 in inline, these are mixed and uniformed in a static mixer 61. Although type of the static mixer 67 is not limited, it is preferable that when a static mixer of NORITAKE Co., Ltd. having 80 mm to 200 mm of pipe diameter is used, there are 24 to 60 elements therein. Other inline mixers having same mixing performance, such as Sulzer mixer of Sulzer Corporation, and HiMixer of Toray Industries, Inc. may be preferably used. The dope is casted on the support from a casting die 70.

In the present invention, it is preferable that the additive liquid (especially the UV-absorbing agent solution) 60 and the matting agent liquid 61 are mixed in the dope 36 right before the casting. The dope 36 needs to be applied a bubble removing process before the casting. If the UV-absorbing agent is added in the dope 36 before the bubble removing process, there is possibility of decomposing the UV-absorbing agent in the dope 36 in the bubble removing process. Further, as the matting agent, silicon dioxide or the like insoluble in the organic solvent is generally used. Therefore, if the matting agent is preliminarily mixed into the dope 36, it is possible that the matting agent deposits on the pipes for transporting the dope 36. In addition, the matting agent is possibly caught in the filters of the first and second filtration devices 54 and 57.

As the material of the casting die 70, a precipitation hardened stainless is preferably used. The material has coefficient of thermal expansion of at most 2×10⁻⁵(° C.⁻¹), the almost same anti-corrosion properties as SUS316 in examination of corrosion in electrolyte aqua solution. Further, when the material was dipped in a mixture liquid of dichloromethane, methanol and water, pitting (holes) were not formed on the gas-liquid interface. The surface roughness Ry of a contacting surface of the casting die 30 to the dope is at most 1 μm, a straightness is at most 1 μm/m in each direction, and the clearance of the slit is automatically controlled in the range of 0.5 mm to 3.5 mm. An end of the contacting portion of each lip to the dope was processed so as to have a chamfered radius at most 50 μm through the slit. In the die, the shearing speed is preferably in the range of 1(1/sec) to 5000(1/sec).

Preferably, a width of the casting die 70 is about 1.01 to 1.3 times larger than a width of the product film. Preferably, a device for regulating the temperature of the casting die is attached to the casting die 70 such that the casting is performed with the temperature of the casting die being kept in a predetermined range. Further, preferably the casting die 70 is coathanger type, in which bolts (heat bolts) for automatically adjusting the thickness of the film are provided with predetermined slit intervals in the width direction of the casting die 70. The heat bolts preferably set a casting profile according to the flow volume from the pump 56 by a preset program. The casting profile can be also adjusted by a feedback control based on a measured value from a thickness measurement device (not shown) provided in the film production line 50 (for example, an infrared thickness measurement device). Thus, in the film except of the edge portions, the difference of the thickness at any two points apart is preferably at most 1 μm, and further the difference of the minimal thickness value and the maximal thickness value in the widthwise direction is preferably at most 3 μm, especially at most 2 μm. The variation of the film thickness is preferably in the range of ±1.5 μm to the predetermined film thickness.

Further, lip ends are provided with a hardened layer. In order to provide the hardened layer, there are methods of ceramic coating, hard chrome plating, nitriding treatment and the like. If the ceramics is used as the hardened layer, the grind was possible, the porosity becomes lower, and was not friable and the good corrosion resistance. Further, as the preferable ceramics, there was no adhesive property to the dope. Concretely, as the ceramics, there are tungsten carbide (WC), Al₂O₃, TiN, Cr₂O₃ and the like, and especially tungsten carbide. Note in the present invention the hardened layer is preferably formed by a tungsten carbide coating in a spraying method.

A device for supplying a solvent (not shown) is preferably provided on the both edges of a die slit in order to prevent the discharged dope partially dried to be a solid. Preferably, the solvent to which the dope was dissoluble (for example, a mixture solvent whose composition is dichloromethane 86.5 mass.pct, acetone 13 mass.pct, n-butanol 0.5 mass.pct) is supplied to each bead edge and the air-liquid interface of the slit. To prevent containing foreign material in the casting film, a rate of supplying the solvent is preferably in a range of 0.1 ml/min to 1.0 ml/min. The pump for supplying the dope has a pulsation at most 5%.

Below the casting die 70, there is a belt 73 supported by rollers 71, 72. The belt 73 endlessly and circulatory move in accordance with a rotation of the rollers 71, 72 by a driving device (not shown). The moving speed of the belt 73, namely a casting speed is preferably in the range of 10 m/min to 200 m/min. Furthermore, the rollers 71,72 are connected to a heat transfer medium circulator 74 for keeping a surface temperature of the belt 73 to a predetermined value. In each roller 71,72, there is a heat transfer passage in which a heat transfer medium of the predetermined temperature is fed, so as to keep the temperature of the rollers 71,72 to the predetermined value. Thus the surface temperature of the belt 73 is controlled to the predetermined value. Note that the surface temperature is preferably from −20° C. to 40° C.

Preferably, a width of the belt 73 is about 1.05 to 1.5 times larger than a width of the cast dope. A polishment is preferably made such that a surface roughness Ry is at most 0.05 μm. The material is preferably a stainless, especially SUS 316 having enough corrosion resistance and strength. The thickness unevenness of the belt 73 is preferably at most 0.5%.

A tension on the belt 73 is preferably regulated in a range 10⁴N/m to 10⁵N/m by the drive of two rollers 71,72. The difference of the relative speed of the rollers 71,72 and the belt 73 is preferably at most 0.01 m/min. Further, the fluctuation of the velocity of the belt 73 is preferably at most 0.5%. The length of film meandering in width direction generated by one rotation is preferably at most 1.5 mm. The rotation is preferably regulated by feedback from a detecting device (not shown) which detects the positions of both edges of the belt 73, in order to reduce the film meandering. Further, preferably the positional fluctuation in horizontal directions of the lips and the belt 73 just below the casting die 70, which is generated in the rotation of the roller 71 is regulated to at most 200 μm.

A roller drum (not shown) can be used instead of the rollers 71, 72 and the belt 73. In this case, preferably the rollers rotates with a high accuracy that the deviation of the rotational velocity is at most 0.2%. Preferably a surface roughness of a contacting surface of each of the rollers 71, 72 was at most 0.01 μm. The surface of the each rollers 71, 72 are processed by the hard chrome plating so as to have the enough hardness and durability. Note that the support (the belt 73 or the roller 71, 72) preferably had minimum defect on the surface thereof. Preferably, the number of pinholes whose diameter is at least 30 μm is zero, that of the pinholes whose diameter is at least 10 μm and at most 30 μm is at most 1 per 1 m², and that of the pinholes whose diameter is less than 10 μm is at most 2 per 1 m².

The casting die 70, the belt 73 and the like are contained in a casting chamber 75 to which a temperature controlling device 76 is connected. The temperature in the casting chamber 75 is preferably in the range of −10° C. to 57° C. Further, a condenser 77 is provided for condensing a solvent vapor. The condensed organic solvent is recovered into a recovering device 78, and the reproduction is made for reusing as the solvent for preparing the dope.

The casting die 70 casts the dope on the belt 73 to form a casting film 79, while the dope form a bead above the belt 73. Note that the temperature of the dope is preferably from −10° C. to 57° C. Further, in order to stabilize the formation of the bead, a decompression chamber 80 is preferably provided in a rear side of the bead, so as to control the pressure. Preferably the pressure in the rear side of the bead is decompressed in the range of −10 Pa to −2000 Pa from the pressure of a front side of the bead. Further, preferably the temperature inside the chamber 80 is regulated by a jacket attached to the chamber 80 so as to keep the predetermined temperature. The temperature inside the chamber 80 is preferably higher than a condensation point of the organic solvent in the dope. Preferably an suctioning device (not shown) is provided at the edge portions of the casting die 70 to keep the desired form of the casting bead. Preferably volume of the suction is in a range of 1 L/min to 100 L/min.

The casting film 79 is fed by the moving belt 73, and at the same time it is preferable to feed a drying air from air blowers 81,82,83 such that the organic solvent may evaporate from the casting film 79. Positions of the air blowers are an upper and upstream side, an upper and downstream side, and a lower side of the belt 73. However, the positions are not restricted in this figure. The surface condition of the film sometimes changes when the drying air is applied onto the casting film 79 just after the formation thereof. In order to reduce the change of the surface condition, a wind shielding device 84 is preferably provided. Note that although the belt is used as a support in this figure, a drum may be used as the support. In this case, the surface temperature of the drum is preferably in the range of −20° C. to 40° C.

After having a self-supporting property, the casting film 79 is peeled as a wet film 86 from the belt 73 with support of a peel roller 85. At that time, the content of the remaining solvent is preferably in a range of 20 mass % to 250 mass % to total solid components in the film. Thereafter, the wet film 86 is transported to a tenter 92 through an interval section 90 provided with plural rollers. In the interval section 90, a drying air at a predetermined temperature is fed from an air blower 91 such that the drying of the wet film 86 may proceed. The temperature of the drying air is preferably in the range of 20° C. to 250° C. Note that in the interval section 90, the rotational speed of the rollers in the upstream side is faster than those in the downstream side, so as to draw the wet film 86.

The wet film 86 is dried while transported in the tenter 92, with portions thereof are held by clips. Inside of the tenter 92 is preferably partitioned into plural partitions, one of which has a temperature different from that of other partitions. Note that in the tenter 92 the wet film 86 can be stretched in the width direction. The wet film 86 is preferably stretched in the range of 0.5% to 300% at least whether width or casting direction in whether the interval section 90 or the tenter 92.

The wet film 86 becomes a film 93 containing a predetermined content of the solvent in the tenter dryer 92. Then the film 93 is transported into an edge slitting device 94 for slitting off both edge portions of the film 93. The slit edge portions are conveyed to a crusher 95 with use of a cutter blower (not shown). The crusher 95 crushes the both edge portions into tips, which are reused for preparation of the dope in view of the cost. Note that the slitting off the both edge portions of the film may be omitted. However, it is preferable to slit them off somewhere between the casting of the dope and the winding the film.

The film 93 is transported into a drying chamber 97 in which there are plural rollers 96. The temperature in the drying chamber 97 is not restricted especially, and preferably in the range of 50° C. to 160° C. The drying of the film 93 in the drying chamber 97 is made with wrapping around the pass roller 96 so as to evaporate the solvent. The drying chamber 97 is provided with an adsorbing device 98 for adsorbing and recovering the solvent vapor. The air from which the solvent vapor is removed is sent as the drying air again. Note that the drying chamber 97 is preferably partitioned into plural partitions so as to vary the drying temperature. Further, it is preferable to provide a pre-drying chamber (not shown) between the edge slitting device 94 and the drying chamber 97 so as to make the pre-drying of the film 93. In this case, the deformation of the film which is caused by the accelerate increase of the temperature of the film is prevented.

The film 93 is transported into a cooling chamber 99, and cooled to a room temperature. Note that a moisture control chamber (not shown) may be provided between the drying chamber 97 and the cooling chamber 99. In the moisture control chamber, an air whose moisture and temperature are controlled is fed toward the film 93. Thus the winding defect of the film is prevented when the film 93 is wound.

It is preferable to provide a compulsory neutralization device (neutralization bar) 100 such that the charged voltage may be in the range of −3 kV to +3 kV in transporting the film 93. In FIG. 2, the neutralization device 100 is disposed in a downstream side from the cooling chamber 99. However, the position of the neutralization device 100 is not restricted in this figure. Further, it is preferable to provide a knurling roller 101 for providing a knurling with an embossing processing. Note that the unevenness in the area in which the knurling is provided is preferably in the range of 1 μm to 200 μm.

Defects of the film 93 are detected by an online defect detector 102 right before reaching to a winding chamber 103. The detection system is not limited. For example, a CCD system, a laser scattering system or any other known system can be used. However, the laser scattering system is most preferable. In the laser scattering system, the running film is scanned in width direction thereof with laser light emitted from an light emitter positioned one side of the film, and a light receiver positioned another side of the film receives the laser light passed through the film. The light receiver detects the scattering of the laser light, so as to recognize the existence of foreign matters. Detection limit of the detector 102 is not limited, however, is preferably at least 30 μm, particularly at least 20 μm, and especially at least 10 μm. If the detection limit becomes smaller, the possibility of causing the deterioration of the optical properties of the film becomes smaller. However, the applicant found that the film 93 satisfies the optical properties required to be a base film of an optical film of the present invention if there are foreign matters whose size is below 10 μm in the film 93.

At last, the film 93 is wound around a winding shaft 104 in a winding chamber 103. The winding is preferably made with applying a predetermined tension by a press roller 105, and it is preferable to change the tension from a start to an end of the winding little by little. The length of the film 61 to be wound is preferably at least 100 m, and a width thereof is preferably at least 600 mm, and especially from 1400 mm to 1800 mm. However, even if the width is more than 1800 mm, the present invention is effective. Further, in the present invention, the thickness of the film to be produced is in the range of 15 μm to 100 μm.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. When the co-casting is performed, a feed block may be attached to the casting die, or a multi-manifold type casting die may be used. A thickness of upper and/or lowermost layer of the multi-layer casting film on the support are/is preferably in the range of 0.5% to 30% to the total thickness of the multi-layer casting film. Furthermore, in the co-casting method, when the dopes are cast onto the support, it is preferable that the lower viscosity dope may entirely cover over the higher viscosity dope. Furthermore, in the co-casing method, it is preferable that the inner dope is covered with dopes whose alcohol contents are larger in the bead from a die to the support.

Note that Japanese Patent Laid-open publication No. 2005-104148 teaches in detail the structure of the casting die and the support, drying conditions in each processes (such as the co-casting, the peeling and the stretching), a handling method, a winding method after the correction of planarity and curling, a recovering method of the solvent, a recovering method of film and the like. The description of the above publication may be applied to the present invention.

[Characteristics, Measuring Method]

The laid-open publication No. 2005-104148 teaches the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of glow discharge treatment, atmospheric pressure plasma discharge treatment, UV radiation treatment, corona discharge treatment, flame treatment, and acid or alkali treatment.

[Functional Layer]

A primary coating may be made over at least one surface of the cellulose acylate film. Further, it is preferable to provide other functional layers for the cellulose acylate film as a film base so as to obtain a functional material. The functional layers may be at least one of antistatic agent, cured resin layer, antireflection layer, adhesive layer for easy adhesion, antiglare layer and an optical compensation layer.

Conditions and methods of performing a surface treatment and providing a functional layer with several functions and characteristics are described in the laid-open publication No. 2005-104148.

Preferably, the functional layer contains at least one sort of surface active agent in the range of 0.1 mg/m² to 1000 mg/m². Further, preferably, the functional layer contains at least one sort of lubricant in the range of 0.1 mg/m² to 1000 mg/m². Further, preferably, the functional layer contains at least one sort of matting agent in the range of 0.1 mg/m² to 1000 mg/m². Further, preferably, the functional layer contains at least one sort of antistatic agent in the range of 1 mg/m² to 1000 mg/m².

[Application]

The cellulose acylate film can be used as the protective film in a polarizing filter. To obtain a LCD, two polarizing filters, in each of which the cellulose acylate film is adhered to a polarizer, are disposed so as to sandwich a liquid crystal layer. The laid-open publication No. 2005-104148 discloses TN type, STN type, VA type, OCB type, reflection type, and other example in detail. To these types can be applied the film of the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film in the polarizing filter simultaneously. The restriction thereof described in the laid-open publication No. 2005-104148 can be applied to the present invention.

In addition, a cellulose triacetate film (TAC film) having superior optical characteristics can be obtained according to the present invention. The TAC film can, be used as a base film of a photosensitive material or a protective film in a polarizing filter. The TAC film is also used as an optical compensation film for widening a view angle of a liquid crystal display used for a TV monitor. In this case, preferably the TAC film also has the function of the protective film in the polarizing filter. Accordingly, the TAC film can be used for an IPS (In-Plane Switching) mode, an OCB (Optionally Compensatory Bend) mode, a VA (Vertically Aligned) mode and the like as well as for a conventional TN (Twisted Nematic) mode.

### EXAMPLE

Example of the present invention was explained. However, the present invention was not restricted in the example.

[Composition]

| | |
|---|---|
| Cellulose triacetate | 89.3 wt. % |
| (substitution degree of acetyl group was 2.84, | |
| acetylic degree was 61.0%, viscometric average | |
| degree of polymerization was 306, moisture content | |
| was 0.2 mass. %, viscosity of 6% by mass of | |
| dichloromethane solution was 420 mPa · s, | |
| powder whose average of particle diameter was | |
| 1.5 mm and standard deviation was 0.5 mm) | |
| Triphenylphosphate | 7.1 wt. % |
| Biphenyldiphenylphosphate | 3.6 wt. % |

To these solid materials 100 pts.wt., a mixture solvent of following compounds was added:

| | |
|---|---|
| Dichloromethane | 92 wt. % |
| Methanol | 8 wt. % |

The mixture of the solid materials and the mixture solvent was stirred to make the dissolution so as to obtain the dope 36, in which the content of the solid materials was 18.5 wt. %.

The UV-absorbing agent solution 60 included following compounds:

UV-aborbing agent a:

| | |
|---|---|
| 2(2′-hydroxy-3′,5′-di-tert-butylphenyl)-5- | 5.83 wt. % |
| chlorobenzotriazole | |

UV-absorbing agent b:

| | |
|---|---|
| 2(2'′-hydroxy-3′,5′-di-tert-amylphenyl)- | 11.66 wt. % |
| benzotriazole | |
| Cellulose triacetate | 1.48 wt. % |
| (same thing as in the dope) | |
| Triphenylphosphate | 0.12 wt. % |
| Biphenyldiphenylphosphate | 0.06 wt. % |
| Dichloromethane | 74.38 wt. % |
| Methanol | 6.47 wt. % |

The prepared UV-absorbing agent solution 60 was filtrated twice by a filter of 10 μm (AstroPore of Fuji Photo Film Co., Ltd.), and then stored in the stock tank 62.

The matting agent liquid 61 included following compounds:

| | |
|---|---|
| Silica | 2.00 wt. % |
| (AEROSIL R972 of NIPPON AEROSIL CO., LTD.) | |
| Cellulose triacetate | 2.00 wt. % |
| (same thing as in the dope) | |
| Triphenylphosphate | 0.16 wt. % |
| Biphenyldiphenylphosphate | 0.08 wt. % |
| Dichloromethane | 88.10 wt. % |
| Methanol | 7.66 wt. % |

The prepared matting agent was dispersed by an attritor such that the volume average particle size became 0.5 μm. Particle size distribution measuring apparatus LA920 of HORIBA, Ltd. was used for measuring the volume average particle size. The dispersed liquid was filtrated twice by a filter of 10 μm (AstroPore of Fuji Photo Film Co., Ltd.), and then stored in the stock tank 63.

Note that in the cellulose triacetate used in the example, content of remaining acetic acid was at most 0.1 mass. %, content of Ca was 58 ppm, content of Mg was 42 ppm, content of Fe was 0.5 ppm, content of Fe was 0.5 ppm, content of releasing acetic acid was 40 ppm, and content of ion sulfate was 15 ppm. Degree of acetyl at 6^{th} position was 0.91 and that content was 32.5% of all acetyl and content of TAC extracted by the acetone was 8 mass. %. A ratio of the average of molecular weight by weight to the average of molecular weight by number was 2.5. And yellow index of the obtained TAC was 1.7, haze was 0.08 and transparency was 93.5%. Tg (glass transition point measured by DSC) was 160° C. and calorific value in crystallization was 6.4 J/g. This was called cotton material TAC in below description.

The film was produced in the film production line 50 as shown in FIG. 2. The dope 36 in the reserve tank 30 was transported into a stock tank 52 by a high-precision gear pump 51. This pump 51 has the function to boost the pressure in the primary side. The pressure in the primary side was controlled to be 0.8 MPa by feedback for the upstream side of the pump 15. The volume efficiency of the pump 15 was 99.2%. And the fluctuation of the volume of discharge was at most 0.5%. The pressure of discharge was 1.5 MPa.

The dope 36 in the stock tank 52 was transported to the first filtration device 54 by a pump 53 (whose volume efficiency was 96%, fluctuation of the volume of discharge was at most 2%, pressure of discharge was in a range of 0.5 MPa to 1.2 MPa). As the filter of the first filtration device 54, a paper filter (#63 of Toyo Roshi Kaisha, Ltd.) was used. The filtrated dope 36 was stocked in the stock tank 55 with its temperature kept at 36° C.

Then the dope 36 was transported to the second filtration device 57 by a pump 56 (whose volume efficiency was 96%, fluctuation of the volume of discharge was at most 2%, pressure of discharge was in a range of 0.5 MPa to 1.5 MPa). The filter 59 of the second filtration device 57 was formed of sintered metal fiber, pleated to a cylindrical shape. The material of the metal fiber was SUS316L. The average diameter of the metal fiber of the first layer 59a was 8 μm, that of the second layer 59b was 4 μm, and that of the third layer (lowermost layer) 59c was 20 μm. The filter 59 was a filter recycled by the following manner. After a new filter was used for filtration until reaching 1.0 MPa of filtration pressure (at this condition the filter was clogged), cleansing solvent was flew through the used filter in a counter direction of filtration and the filter was dried, then the filter was roasted two hours in a furnace having 400° C. of inside temperature.

The UV-absorbing agent solution 60 and the matting agent liquid 61 were transformed to a static mixer 66 by pumps 64, 65 respectively. The static mixer 66 had 25.4 mm of pipe diameter and 76 elements. The UV-absorbing agent solution 60 and the matting agent liquid 61 were mixed and fed into the dope 36. The dope 36 containing the UV-absorbing agent solution 60 and the matting agent liquid 61 were mixed by a static mixer 67. Note that the added amount of the UV-absorbing agent was controlled to 1.04 wt. % to the content of the solid materials (the polymer and the plasticizer) in the dope 36. The added amount of the matting agent was controlled to 0.13 wt. % to the content of the solid materials in the dope 36.

The casting was performed such that the flow volume of the dope 36 at an exit of the casting die 70 was regulated so as to make the film having 80 μm thickness. The width of the dope was 1700 mm at the exit of the die 70. In order to regulate the temperature of the dope 36, a jacket (not shown) was provided with the casting die 70 and the heat transfer medium was supplied inside the jacket. The temperature of the heat transfer medium 50 at an inlet of the jacket was 36° C. The temperature of the casting die 70 and pipelines was controlled to 36° C. in the casting. The casting die 70 was coathanger type.

In a primary side from the casting die 70, the decompression chamber 80 was disposed, whose decompression rate can be adjustable depending on the casting speed, such that there would be a pressure difference in the range of 1 Pa to 5000 Pa between up- and downstream sides. The pressure difference was set such that the bead became 20 mm to 50 mm length. Further, the temperature of the decompression chamber was also regulated to be higher than a condensation temperature of the gas around the casting bead. There was labyrinth packing (not shown) in front and rear sides of the bead. Further, there were openings in both sides. Further, in order to compensate the disorder of the both edges of the casting beads, the edge suctioning device (not shown) was used.

The material of the casting die 70 was a precipitation hardened stainless. The material had coefficient of thermal expansion of at most 2×10⁻⁵(° C.⁻¹), the almost same anti-corrosion properties as SUS316 in examination of corrosion in electrolyte aqua solution. Further, when the material was dipped in a mixture liquid of dichloromethane, methanol and water, pitting (holes) were not formed on the gas-liquid interface. The surface roughness Ry of a contacting surface of the casting die 110 to the dope was at most 1 μm, a straightness was at most 1 μm/m in each direction, and the clearance of the slit was controlled to 1.5 mm. The end of the contacting portion of each lip to the dope was processed so as to have the chamfered radius at most 50 μm through the slit. In the die, the shearing speed was in the range of 1(1/sec) to 5000(1/sec). On the lip ends of the casting die 70, the hardened layer was formed by the tungsten carbide coating in the spraying method.

On the both edges of the die slit, the discharged dope is partially dried to be a solid. In order to prevent the solidification of the dope, a mixture solvent (a mixture solvent whose composition is dichloromethane 50 wt.pct, methanol 50 wt.pct) to which the dope was dissoluble was supplied at 0.5 ml/min to each bead edge and the air-liquid interface of the slit. The pump for supplying the dope has a pulsation at most 5%. Further, the pressure in the rear side (or the upstream side) of the bead was decreased by 150 Pa. Further, in order to make the temperature in the decompression chamber 80 constant, the jacket (not shown) was provided. Into the jacket, the heat transfer medium whose temperature was regulated to 35° C. was fed. The airflow of the edge suctioning was in the range of 1 L/min to 100 L/min, and in this embodiment, the air flow rate was regulated in the range of 30 L/min to 40 L/min.

The belt 73 was a stainless endless belt that was 2.1 m in width and 70 m in length. The thickness of the belt 73 was 1.5 mm and the polishment was made such that a surface roughness was at most 0.05 μm. The material was SUS 316 and had enough corrosion resistance and strength. The thickness unevenness of the belt 53 was at most 0.5%. The belt 73 was rotated by drive of two rollers 71,72. At this time, the tension of the belt 73 was regulated to 1.5×10⁵ N/m², and the difference of the relative speed of the rollers 71,72 and the belt 73 was at most 0.01 m/min. Further, the velocity fluctuation of the belt 73 was at most 0.2%. The rotation was regulated with detecting the positions of both edges such that the film meandering in width direction for one rotation might be regulated to at most 1.5 mm. The belt 73 is provided in the casting chamber 75 with a device to control the fluctuation of the airflow pressure (not shown).

Into the rollers 71, 72 are fed the heat transfer medium so as to perform the temperature regulation of the belt 73. Into the roller 71 in a side of the casting die 70 was fed the heat transfer medium (liquid) at 5° C. and into the roller 72 was fed the heat transfer medium (liquid) at 40° C. The surface temperature of the middle portion of the belt 73 just before the casting was 15° C., and the temperature difference between both side edges was at most 6° C. Note that the belt 73 preferably had no defect on surface, and especially preferably, the number of pinholes whose diameter was at least 30 μm was zero, that of the pinholes whose diameter was from 10 μm to 30 μm was 1 per 1 m², and that of the pinholes whose diameter was less than 10 μm was 2 per 1 m².

The temperature of the casting chamber 75 was kept to 35° C. by a temperature regulator 76. The dope is cast onto the belt 73 to form the casting film 79, to which the drying air of parallel flow to the casting film 79 was fed at first to dry. An overall coefficient of heat transfer between the drying air and the casting film was 24 kcal/(m²·hr·° C.). Airs were fed from the air blowers 81-83 such that the temperature of the drying air from the blower 81 in the upper and upstream side might be 135° C., that from the blower 82 in the upper and downstream side might be 140° C., and that from the blower 83 in the lower side might be 65° C. The saturated temperature of each drying wind was about −8° C. The oxygen concentration in the dry atmosphere was held at 5 volume %. Note that the displacement of air to Nitrogen gas is made so as to keep this oxygen concentration at 5 volume %. And in order to recover the solvent in the casting chamber 75 by condensing, the condenser 77 was provided and the temperature at the exit of the casting chamber 75 was set to −10° C.

A wind shielding board 84 was provided in the casting chamber such that the drying air did not directly apply to the dope 36 and the casting film 79 for five seconds from start of the casting, so as to reduce the fluctuation of the static pressure to at most ±1 Pa. When the ratio of solvent in the solution casting film 79 reached to 50 mass. % (dry measure basis), the solution casting film 79 was peeled as the wet film 86 from the casting belt 73 supported by the peeling roller 85. Note that the content of the solvent (dry measure basis) was calculated on a following formula:
Content of Solvent={(x−y)/y}×100
x: weight of a sampling film before the drying
y: weight of the sampling film after the drying
At this time, the ratio of velocity of the peeling to that of the running belt 73 was regulated in the range of 100.1% to 110%. The surface temperature of the peeled film 86 was 15° C. An average speed of the drying of the solvent in the casting film 79 on the casting belt 73 was 60 mass. % (dry measure basis)/min. The solvent gas generated in the drying was condensed and liquefied by the condenser 77 where a temperature was −10° C. and recovered by the recovering device 78. A water content in the recovered solvent was regulated to at most 0.5%. The dried air in which the solvent was removed was heated again and reused as the drying air. The wet film 86 was transported into the tenter dryer 92 through the interval section 90. In this transporting, the drying air (40° C.) was fed to the wet film 86 from the air blower 91. Note that the tension of about 50 N/m was applied to the wet film 86 while the wet film 86 was transported by the rollers in the interval section 90.

The wet film 86 was transported in the drying zone in the tenter 92, then the both side edge portions of the wet film 86 were held by clips. In this time, the wet film 86 was dried by air. The clips were cooled by supplied with the heat transfer medium at the temperature of 20° C. The clips were transported by use of chain and sprocket in the tenter 92, and a fluctuation of velocity of the sprocket was at most 0.5%. The tenter had three zones, in which the temperature of drying air was respectively 90° C., 110° C., and 120° C. in this order from the upstream side. The gaseous composition of the drying air was the same as that in the saturated gas at the temperature of −10° C. An average speed of the drying of the solvent in the wet film 86 in the tenter 92 was 120 mass. % (dry measure basis)/min. The condition in the drying zone was regulated such that the content of the remaining solvent at the exit of the tenter 92 was 7 mass. %. The wet film 86 was transported in tenter 92 with being stretched in the width direction. Note that when the width of the wet film 86 before being stretched was 100%, the width of the stretched wet film 86 was 103%. The stretching ratio of the film from the peeling roller 85 to the entrance of the tenter 92 was 102%. Inside the tenter 92, the difference of real stretching ratio was at most 10% between any two points remote at least 10 mm from the position of the clip starting the holding of the film, and was at most 5% between any two points remote 20 mm from each other. A ratio of the length between the position where the clips started holding film and the position where the clips ended the holding, to the length between the entrance and the exit of the tenter 92, was 90%. The solvent vaporized in the tenter 92 was condensed, liquefied at the temperature of −10° C. and recovered. The condenser was provided for the condensation and the recovering. The exit temperature of the condenser was set up to −8° C. And the condensed solvent was reused after the water content therein was conditioned at most 0.5 mass. %. Then the dried wet film 86 is transported from the tenter 92 as a film 93.

The side edge portions of the film 93 were slit off by the edge slitting device 94 within thirty seconds after exiting from the tenter 92. 50 mm of the lateral sides of the film 93 were cut by a NT type cutter, and the cut portions were sent to a crusher 95 by a cutter blower (not shown), and crushed into chips whose average size was approximately 80 mm². The chips were reused with TAC flake as the raw material of the dope. In the tenter 92, the oxygen concentration in the dry atmosphere was held at 5 volume %. Note that the displacement of air to Nitrogen gas is made so as to keep this oxygen concentration at 5 volume %. The film 93 was pre-heated in a pre-drying chamber (not shown) where the 100° C. of drying air was supplied, before dried in the drying chamber 97 with high temperature.

The film 93 was dried at the high temperature in the drying chamber 97. The drying air was fed in the drying chamber 97 such that inside the chamber was partitioned into four partitions, and the respective air at 120, 130, 130 and 130° C. was fed into the respective partitions arranged in an order from the upstream side to downstream side from air blowers (not shown). The tension of the film 93 given by the roller 96 in the transporting was regulated in a range of 50 N/m to 150N/m and the film 93 was dried for ten minutes so that the content of the remaining solvent in the film 93 finally became to 0.3 mass. %. A wrapping angle (arc of contact) of the roller 96 in winding the film 93 was 90° or 180°. The material of the roller 96 was aluminum or carbon steel, and the hard chrome coating was made on the surface of the roller 96. Two types of the rollers 96 were used. In the first type, the surface of the roller was smooth, and in the second type, matting process is applied on the surface of the roller by blasting. The positional fluctuation (or eccentricity) of the film 96 on the rotating roller 96 was within 50 μm, and the deflection of the roller 96 under 100N/m tension was within 0.2 mm.

The solvent vapor in the drying air was removed by the adsorbing device 98. The adsorbing agent was activated carbon, and the desorption was performed by the dried nitrogen. The water content in the recovered solvent was reduced to at most 0.3 mass. %, and thereafter the recovered solvent was used for the solvent for preparing the dope. The drying air includes not only the solvent vapor but also the plasticizer, the UV-absorbing agent and the like having high boiling points. These components were removed by cooling with use of a cooling device and a preadsorber, and recycled. The adsorption and desorption conditions were set so that VOC (volatile organic compounds) in the exhaust gas might become at most 10 ppm. An amount of the solvent recovered by the condensing method was approximate 90 mass. % of all vapor solvent, and the rest of the vapor solvent was mainly recovered by the adsorption.

The dried film 93 was transported into a first moisture control chamber (not shown). The drying air at 110° C. was fed into an interval section between the drying chamber 97 and the first moisture control chamber. The air with the temperature of 50° C. and the dew point of 20° C. was fed in the first moisture control chamber. Further, in order to reduce the generation of the curling, the film 93 was transported into a second moisture control chamber (not shown). The air with the temperature 90° C. and the humidity of 70% was directly fed onto the film 93 in the second moisture control chamber.

The film 93 after the moisture thereof being controlled was cooled to equal to or less than 30° C., and both edge portions thereof were slit off or trimmed by an edge slitting device (not shown). A neutralization device (neutralization bar) 100 was provided so that the charged voltage in the film 93 in transporting was kept in a range of −3 kV to +3 kV. Further, then knurling on the both sides of the film 93 was made with use of a knurling roller 101. The knurling was given such that the film 93 was embossed from one of the both sides. An average width of the area for knurling was 10 mm, and the pressure of the knurling roller 101 was determined so that an average height of convex might be 12 μm higher than the average thickness of the film 93.

The number of foreign matters in the film 93 was counted by the online defect detector 102. As the detection system, the laser scattering system is used. Detection limit of the detector 102 was at least 30 μm. As the result, there were 24 foreign matters in the 500 m of the product film. When the foreign matters were checked by a microscope, no metal fabric was confirmed.

Thereafter, the film 93 was transported into the winding chamber 103 in which the temperature and the humidity were kept to 28° C. and 70% RH (relative humidity). Further, an ionizer (not shown) was provided in the winding chamber 103 so that the charged voltage in the film 93 was kept in a range of −1.5 kV to +1.5 kV. The width of the product film 93 (80 μm thickness) was 1330 mm. The diameter of the winding shaft 104 in the winding chamber 103 was 169 mm. The tension of the film 93 was 400N/m in the beginning of winding, and was 150N/m in the end of winding. The total length of the wound-up film was 3940 m. One length period of weaving measurement on the winding shaft 104 was 400 m, and a fluctuation range (oscillation range) in the width direction of the winding film was ±5 mm. The pressure of the press roller 105 toward the winding shaft 104 was 40N/m. In the winding, the temperature of the film was 25° C., the water content was 1.4 mass, %, and the content of the remaining solvent was 0.3 mass. %. An average speed of the drying of the solvent in the film in the entire process was 20 mass. % (dry measure basis)/min. There did not cause winding looseness, creases and the like while the winding. Further, the winding deviation did not cause in 10 G impact test. In addition, the appearance of the film roll was in a good condition. Although 24 foreign matters were detected by the online defect detector 102, none of the foreign matters was metal fiber-based.

The film roll was stored in the storing rack where a temperature of 25° C. and a humidity of 55% RH for one month. Then, the film roll was examined as same as the above described. According to the examination, any significant change was not recognized. Further, adhesion of the film was not recognized in the film roll. After producing the film 93, there was no remaining casting film 79 on the casting belt 73.

A comparative experiment was carried out in the conditions as same as Example, except that filter 59, in which the average diameter of the metal fiber of the first layer 59a was 8 μm, that of the second layer 59b was 4 μm, and that of the third layer (lowermost layer) 59c was 8 μm, was used. When the number of foreign matters in the film 93 was counted by the online defect detector 102, the result was that there were 80 foreign matters in the 500 m of the product film. In addition, 60 of the foreign matters were metal fiber-based.

According to the above experiments, it found that the solution not including the breakages from the metal fiber could be produced even if the sintered metal fiber filter has large filtration accuracy.

### INDUSTRIAL APPLICABILITY

The present invention can be preferably used for filtering dope including chlorinated solvent. In addition, the present invention can be preferably used for producing optical film from dope including chlorinated solvent.

1. A dope filtering method for filtering a dope containing a cellulose acylate and a solvent, comprising the steps of:
filtering said dope with use of a first filter formed of sintered metal fibers; and
filtering said dope filtered by said first filter, with use of a second filter formed of sintered metal fibers whose average diameter is in a range of 15 μm to 60 μm and larger than that of said first filter.

2. A dope filtering method described in claim 1, wherein said first filter has plural layers, and an average diameter of said sintered metal fibers of at least one of said layers is in a range of 4 μm to 8 μm.

3. A dope filtering method described in claim 2, wherein said first filter and said second filter have cylindrical shapes, and are concentrically arranged such that said first filter is outside and said second filter is inside.

4. A dope filtering method for filtering a dope containing a cellulose acylate and a solvent with use of a filter, said filter having plural layers formed of sintered metal fibers and arranged in a dope flow direction, an average diameter of said sintered metal fibers of said each layer being different to that of said other layers, and said average diameter of said sintered metal fibers of said layer positioned at most downstream side in said dope flow being in a range of 15 μm to 60 μm and that of at least one of other layers being in a range of 4 μm to 8 μm.

5. A dope filtering method described in claim 4, wherein said filter is roasted in a temperature range of 350° C. to 500° C. to be reused.

6. A dope filtering method described in claim 4, a non-metal filter for filtering said dope being provided in upstream from said sintered metal fiber filter in said dope flow direction.

7. A dope filtering method described in claim 6, wherein said non-metal filter is a paper filter or a fabric filter.

8. A dope filtering method described in claim 4, wherein said solvent is a chlorinated solvent.

9. A dope filtering method described in claim 4, wherein said sintered metal fiber is made from at least one of an austenitic stainless, a martensitic stainless, a ferritic stainless and a combination of them.

10. A solution casting method comprising steps of:
preparing a dope containing a cellulose acylate and a solvent;
filtering said dope with use of a filter, said filter having plural layers formed of sintered metal fibers and arranged in a dope flow direction, an average diameter of said sintered metal fibers of said each layer being different to that of said other layers, and said average diameter of said sintered metal fibers of said layer positioned at most downstream side in said dope flow being in a range of 15 μm to 60 μm and that of at least one of other layers being in a range of 4 μm to 8 μm; and
casting said dope on a support to form a film.

11. A solution casting method described in claim 10, wherein said cellulose acylate is a cellulose triacetate.
